(19) United States
(12) Patent Application Publication
(10) Pub. No.: US 2003/0143357 A1
(43) Pub. Date: Jul. 31, 2003

(54) Biaxially-oriented facestock for conformable pressure-sensitive labels

(76) Inventor: Lori A. Frauenhofer, Fairport, NY (US)

Correspondence Address: EXXONMOBIL CHEMICAL COMPANY, P O BOX 2149, BAYTOWN, TX, 77522-2149, US

(21) Appl. No.: 10/057,852

(22) Filed: Jan. 25, 2002

(51) Int. Cl. B32B 9/00; B32B 33/00

(52) U.S. Cl. 428/40.1

(57) ABSTRACT

An improved facestock for forming conformable pressure-sensitive labels for automated dispensing. The facestock is an extruded multilayer film structure, including a core layer formed of propylene and an ethylene-containing polyolefin. The coextruded biaxially oriented structure exhibits the squeezability and softness characteristics required for a conformable label while maintaining sufficient stiffness for automated dispensing.

### BACKGROUND OF THE INVENTION

The present invention relates to pressure-sensitive labels and, more particularly, to an improved facestock for forming conformable pressure-sensitive labels having sufficient stiffness for automated dispensability.

Pressure-sensitive labels are well known in the art. Typically, such labels are provided by way of a labelstock. As will be appreciated by those skilled in the art, a labelstock generally includes a printable facestock material, a pressure-sensitive adhesive adhered to the side of the facestock opposite the printing and a release liner which covers and protects the adhesive during shipment and storage. To form individual labels, the facestock is printed and then die-cut into discrete sections. The waste material between the discrete sections is thereafter removed to provide individual labels each being attached to the continuous liner. The die-cut section of facestock, together with the pressure-sensitive adhesive adhered thereto, is typically referred to as a pressure-sensitive label.

To apply the labels to a substrate, the die-cut roll of labels is directed over a dispensing apparatus, e.g., a peel plate or other apparatus, which causes the label to separate from the liner such that it can be applied to the substrate. It will be appreciated by those skilled in the art that automated dispensability of individual labels adhered to a continuous liner requires that the individual labels exhibit a sufficient degree of stiffness. Without such stiffness, the label may not separate from the liner as it passes over the dispensing apparatus.

Pressure-sensitive labels are used in a wide variety of applications. Many of these applications are in areas that require the label to be conformable, i.e., in applications where the label is applied to a deformable substrate (e.g., shampoo bottles, lotion tubes, and salad dressing containers) or in applications where the label is applied to a contoured or irregular-shaped container. In the former application, the conformable label allows the underlying substrate to be repeatedly squeezed without creasing, tearing and/or visually marring the label. In the latter application, the conformable label allows smooth application without wrinkling or creasing. Both applications, of course, require that the conformable label remain properly adhered to the substrate.

As mentioned, the stiffness of the label is important to the issue of dispensability, particularly whether such labels may be dispensed from a continuous liner in automated fashion. However, it will be recognized by those skilled in the art that increased stiffness generally leads to decreased conformability of the label. Of course, decreasing stiffness to increase conformability affects the dispensability of the labels. Finally, there is always a commercial interest in downgauging the facestock (i.e., reducing its thickness) to provide savings in material costs. Decreased thickness, of course, also reduces the stiffness of the facestock.

Thus, a suitable facestock must provide an optimum balance between conformability and dispensibiliy. Factors such as the construction and thickness of the facestock, the materials used to form the facestock, and the type and degree of orientation of the facestock affect such characteristics. Preferably, the materials used to form the facestock are less expensive, and can be processed in a cost-efficient manner without any environmental or other drawbacks. The facestock must also provide a good print surface and be well adapted for die-cutting. To date, the prior art has failed to provide a facestock which meets all of these requirements.

There is therefore a need in the art for an improved facestock which is formed in a cost efficient manner and which provides good print performance and die-cuttability, and which provides an optimum balance between conformability and dispensability thus allowing production of lower gauge structures which still retain sufficient stiffness for automated dispensing.

### SUMMARY OF THE INVENTION

The present invention, which addresses the needs of the prior art, relates to a coextruded facestock for forming conformable pressure-sensitive labels suitable for automated dispensing. The facestock includes a core layer having approximately 40-80% of polypropylene and approximately 20-60% of an ethylene-containing polyolefin. The core layer has a thickness of at least about 2.15 mils. The facestock also includes first and second polyolefinic skin layers adhered to opposing sides of the core layer. Each of the skin layers has a thickness of less than approximately 0.1 mils. The facestock is biaxially oriented such that the degree of orientation in the transverse direction exceeds the degree of orientation in the machine direction. The degree of orientation in the transverse direction ranges from about 7 to about 10 and the degree of orientation in the machine direction ranges from about 3.5 to about 6.

The present invention also relates to a labelstock for forming conformable pressure-sensitive labels. The labelstock includes a facestock having sufficient stiffness to allow automated dispensing of labels formed therefrom. In particular, this facestock includes a core layer including approximately 40-80% of polypropylene and approximately 20-60% of an ethylene-containing polyolefin. The facestock further includes first and second polyolefinic skin layers adhered to opposing sides of the core layer. The facestock is biaxially oriented such that the degree of orientation in the transverse direction exceeds the degree of orientation in the machine direction. The degree of orientation in the transverse direction ranges from about 7 to about 10 and the degree of orientation in the machine direction ranges from about 3.5 to about 6. The core layer is at least about 20 times the thickness of one of the skin layers. The labelstock also includes a pressure-sensitive adhesive applied to the outer surface of the second skin layer. Finally, the labelstock includes a release liner covering the pressure-sensitive adhesive and adapted for removal therefrom.

In one preferred embodiment, an acrylic-based coating is adhered to the outer surface of the first skin layer to enhance the printability of the facestock, particularly with respect to the use of UV curable inks. The coating may include a matting agent, and is preferably applied at a coating weight of about 0.5 g/msi to about 1 g/msi.

As a result, the present invention provides an improved facestock which provides excellent print performance and die-cuttability, together with an optimum balance between conformability and dispensability thus allowing production of lower gauge structures which still retain sufficient stiffniess for automated dispensing. Moreover, the improved facestock can be produced using less expensive materials and cost efficient manufacturing processes.

### BRIEF DESCRIPTION OF THE DRAWINGS

FIG. 1 shows a section of labelstock which includes a facestock, pressure-sensitive adhesive and a release liner; and

FIG. 2 shows a section of facestock used to form the labelstock of FIG. 1.

### DETAILED DESCRIPTION OF THE INVENTION

It has been discovered herein that conformable pressure-sensitive labels suitable for automated dispensing and exhibiting very good squeezability, printability and die-cuttability can be provided at a reduced cost in accordance with this invention. This reduced cost results from the ability of the structure described herein to be downgauged (i.e., reduced in thickness) which produces savings in material costs, the use of less expensive materials, and the use of more efficient manufacturing processes.

The conformable pressure-sensitive label of the present invention is formed from labelstock 10, which includes a facestock 12, a pressure-sensitive adhesive 14, and a release liner 16 which covers and thereby protects the pressure-sensitive adhesive during handling and storage. It will be appreciated that there are a plurality of commercially available adhesives and liners for use in these applications. Typically, the adhesive and liner are purchased and applied to the facestock by the purchaser of the facestock prior to labeling of the substrate. Accordingly, such adhesives and liners will not be further discussed herein.

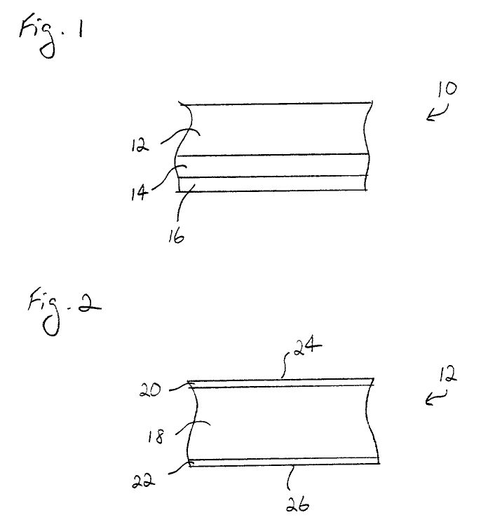

Referring now to FIG. 2, facestock 12 is preferably a multilayer construction formed by simultaneously coextruding a plurality of discrete layers, e.g., core layer 18, first skin layer 20 and second skin layer 22. The resultant coextruded structure is referred to as the facestock. As shown in FIG. 1, adhesive 14 is applied to the outer surface of skin layer 22.

Core layer 18 of facestock 12 is preferably formed from blending an amount of polypropylene with an amount of an ethylene-containing polyolefin. It has been discovered herein that selecting the components of the core layer to control both the amount of polypropylene in the layer (which affects stiffniess/modulus) and the total content of the ethylene in the layer (which affects squeezability/softness/modulus) provides a facestock which when biaxially oriented (as described hereinbelow) exhibits the squeezability and softness characteristics required in a conformable label while substantially maintaining the stiffness of a conventional OPP label thus allowing downgauging versus most other known facestocks. In this regard, a conventional 2 mil OPP label is generally used as a benchmark for measuring/comparing the dispensability of a label.

The core layer includes from about 40% to about 80% of polypropylene and from about 20% to about 60% of the ethylene-containing polyolefin. If the level of the ethylene-containing polyolefin exceeds 60%, the resultant facestock typically lacks the requisite stiffness necessary for dispensability, and if the level is less than 20%, the resultant facestock typically lacks the squeezability/softness needed for conformability. Preferably, the core layer includes from about 45% to about 60% of polypropylene and from about 40% to about 55% of the ethylene-containing polyolefin. The polypropylene is preferably a homopolymer, such as a conventional isotactic polypropylene. The ethylene-containing polyolefin is preferably a random propylene-ethylene copolymer or a propylene-ethylene butylene terpolymer which when present in the designated amount provides the core layer with a total ethylene content of from about 1% to about 5% and, more preferably, from about 2% to about 4%. The ethylene content of the propylene-ethylene copolymer preferably ranges from about 3% to about 8%, while the ethylene content of the propylene-ethylene-butylene terpolymer is preferably greater than about 3%. It is believed that terpolymers wherein the butylene content is significantly greater than the ethylene content will provide facestocks with less satisfactory squeezability.

The core layer has a minimum thickness of about 2.15 mils, and preferably has a thickness of from about 2.3 mils to about 2.4 mils, although it is contemplated that thicker core layers with thicknesses up to and exceeding 3 mils can be used herein. The core layer typically constitutes at least about 90% of the overall thickness of the coextruded facestock, preferably at least about 92% of the overall thickness of the facestock and, more preferably at least about 96% of the overall thickness of the facestock.

Skin layers 20 and 22 are preferably identical in construction and thickness, and formed from a polyolefin-based material. The skin layers, particularly skin layer 20, may include print-enhancing materials and/or be treated to enhance printability. It is contemplated that intermediate tie layers may be disposed between the core and skin layers in certain preferred embodiments to enhance adhesion of the skin layer to the core layer, particularly in those embodiments wherein skin layer 20 includes print-enhancing materials. The skin layers may also include various additives, such as anantiblock agent. In one preferred embodiment, the skin layer is formed from a random propylene-ethylene copolymer including from about 500 ppm to about 2500 ppm of a silica-type antiblock. The thickness of each skin layer is less than about 0.15 mils, and preferably less than about 0.1 mil. In one preferred embodiment, each skin layer has a thickness of about 0.05 mils. Each skin layer preferably constitutes less than about 5% of the overall thickness of the extruded structure and, more preferably, less than about 4% of the overall thickness of the extruded structure. In one preferred embodiment, each skin layer constitutes about 2% of the overall thickness of the coextruded structure.

The outer surface 24 of skin layer 20 is preferably coated with an acrylic-based coating for enhanced printability, particularly with respect to the use of UV curable inks. If necessary, surface 24 can be treated prior to application of the coating. In one preferred embodiment, the coating is an acrylic having adhesion-promoting functional groups filled with a matting agent (the matting agent providing the facestock with a hazy appearance). The coating, which may include various known additives, is preferably applied at a coating weight of about 0.5 g/msi to about 1 g/msi which typically provides a coating thickness of approximately 0.03-0.06 mils. A second coating for enhancing the adhesion of the pressure-sensitive adhesive can be applied to outer surface 26 of skin layer 22 in certain preferred embodiments. Outer surface 26 may be treated prior to application of the second coating.

The coextruded facestock is biaxially oriented by stretching the facestock from about 7 times to about 10 times in the transverse direction and from about 3.5 times to about 6 times in the machine direction. Preferably, the facestock is stretched approximately 8 times in the transverse direction and approximately 4.5 times in the machine direction. The biaxially oriented material (which is stretched significantly in the transverse direction) provides a facestock possessing the requisite conformability properties, while maintaining sufficient stiffness to allow automated dispensing even at reduced thicknesses, e.g., 2.4 to 2.5 mils or less.

### EXAMPLES

The following examples are directed to biaxially oriented facestock produced in accordance with the present invention. Each of the facestocks includes a core layer disposed between two skin layers. The overall thickness of each facestock was approximately 2.5 mils, with the individual layers forming a ratio of approximately 2:96:2. The skin layers were formed from a propylene-ethylene copolymer (Fina 8573 HB), which contains a standard antiblock package. Finally, each facestock was oriented approximately 4.5 times in the machine direction and approximately 8 times in the transverse direction.

Squeezability was evaluated using an in-house squeeze tester, which uses air pressure to deflate/inflate bottles and simulates repeated hand squeezing. A subjective rating scale of 0-8 was used to rate samples, where 0 is a perfect label that has no creases or tunneling of adhesive after squeeze testing. In general, each ˜½″ to ˜¾″ crease adds 1 to the rating.

Comparative Example I

Two samples of a facestock were coextruded having a core layer formed from polypropylene (Fina 3371) and propylene-butylene copolymer (Cefor DS4DO5). The individual samples were formed with 40% and 60% of the copolymer. The oriented samples exhibited the following characteristics: poor squeezability, good softness, moderate to good stiffniess, low to moderate modulus.

Comparative Example II

Three samples of a facestock were coextruded having a core layer formed from polypropylene (Fina 3371) and polybutene-1 (Basell PB 8240). The individual samples were formed with 10%, 20% and 30% of polybutene-1. The oriented samples exhibited the following characteristics: poor squeezability, moderate to high stiffness, moderate to high TD modulus, poor shrink stability.

Comparative Example III

Two samples of a facestock were coextruded having a core layer formed from polypropylene (Fina 3371) and syndiotactic polypropylene (Fina EOD 96-30). The individual samples were formed with 25% and 50% syndiotactic polypropylene. The oriented samples exhibited the following characteristics: very good squeezability, low stiffness, low modulus, poor processability, high resin cost.

Comparative Example IV

Three samples of a facestock were coextruded having a core layer formed from polypropylene (Fina 3371) and propylene-ethylene-butylene terpolymer (Chisso XPM 7800). The individual samples were formed with 20%, 30% and 40% of the terpolymer. The oriented samples exhibited the following characteristics: fair to poor squeezability, moderate stiffness, moderate modulus.

Comparative Example V

A sample facestock was coextruded having a core layer formed from 100% propylene-ethylene copolymer (Fina 8573). The oriented samples exhibited the following characteristics: good squeezability, good softness, low to moderate stiffness, low modulus, poor processability, poor shrink stability.

Example VI

A sample facestock was coextruded having a core layer formed from 60% polypropylene (ExxonMobil 4712) and 40% propylene-ethylene copolymer (Fina EOD 94-21). The oriented samples exhibited the following characteristics: very good squeezability (averaging less than 1 on the squeeze-rating scale), moderate softness, intermediate stiffness, intermediate modulus, good shrink stability.

Example VII

A sample facestock was coextruded having a core layer formed from 45% polypropylene (ExxonMobil 4712) and 55% propylene-ethylene copolymer (Fina EOD 94-21). The oriented samples exhibited the following characteristics: very good squeezability (averaging less than 0.5 on the squeeze-rating scale), good softness, moderate stiffness, low modulus, moderate shrink stability.

Example VIII

A facestock was coextruded having a core layer formed from 50% polypropylene (ExxonMobil 4712) and 50% propylene-ethylene-butylene terpolymer (Chisso XPM 7700). The oriented samples exhibited the following characteristics: very good squeezability (averaging less than 0.5 on the squeeze-rating scale), moderate softness, moderate stiffniess, moderate modulus, good shrink stability.

Discussion of Examples

Although each of the comparative examples exhibited certain desirable properties, none of the comparative examples exhibited a range of properties sufficient to provide a conformable label suitable for automated dispensing. In particular, Comparative Examples I, II and IV all lacked (at a minimum) the necessary degree of squeezability, while Comparative Examples III and V lacked (at a minimum) the necessary processability.

As discussed, Examples VI, VII and VIII were produced with blends of polypropylene and random propylene-ethylene copolymers or propylene-ethylene-butylene terpolymers, using biaxially orientation techniques which facilitate production and minimize manufacturing costs. The total ethylene content in the various core layers ranged from about 2% to about 4%.

These facestock samples exhibited a surprising degree of softness, similar to vinyl, especially at higher copolymer/terpolymer percentages. The samples also exhibited excellent squeezability and die-cutting, as well as good dispensability. Coated versions for enhanced UV printability exhibited excellent print adhesion. Overall, the sample facestocks of Examples VI, VII and VIII exhibited a better balance of properties than control samples of commercially-available conformable facestock.

It is believed that the “softness” associated with the facestock samples of Examples VI, VII and VIII correlates generally with lower modulus, especially in the MD direction, and with increasing amounts of the ethylene-containing polyolefin. Squeeze performance, however, is believed to be more specific to the resin composition, with random propylene-ethylene copolymers demonstrating more consistent squeezability.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included within the scope of the following claims.

What is claimed is:

1. A coextraded facestock for forming conformable pressure sensitive labels suitable for automated dispensing, comprising:
a core layer including approximately 40-80% of polypropylene and approximately 20-60% of an ethylene-containing polyolefin, said core layer having a thickness of at least about 2.15 mils;
first and second polyolefinic skin layers adhered to opposing sides of said core layer, each of said skin layer having a thickness of less than approximately 0.1 mils; and
wherein said coextruded core and skin layers are biaxially oriented such that the degree of orientation in the transverse direction exceeds the degree of orientation in the machine direction, the degree of orientation in said transverse direction ranging from about 7 to about 10 and the degree of orientation in said machine direction ranging from about 3.5 to about 6.

2. The facestock according to claim 1, wherein said core layer includes approximately 45 to 60% of said polypropylene and approximately 40 to 55% of said ethylene-containing polyolefin.

3. The facestock according to claim 2, wherein said ethylene-containing polyolefin provides said core layer with a total ethylene content of approximately 2%-4%.

4. The facestock according to claim 3, wherein said ethylene-containing polyolefin is selected from the group consisting of random propylene-ethylene copolymers and propylene-ethylene-butylene terpolymers.

5. The facestock according to claim 1, wherein each of said skin layers has a thickness of from about 0.03 mils to about 0.07 mils.

6. The facestock according to claim 5, wherein said core layer has a thickness of from about 2.3 mils to about 2.4 mils.

7. The facestock according to claim 6, wherein each of said skin layers is formed of a polymer-ethylene copolymer and includes from about 500 ppm to about 2500 ppm of an antiblock agent, and wherein the degree of orientation in said transverse direction is approximately 8 and the degree of orientation in said machine direction is approximately 4.5.

8. The facestock according to claim 1, further comprising an acrylic-based coating adhered to the outer surface of said first skin layer.

9. The facestock according to claim 8, wherein said coating includes a matting agent.

10. The facestock according to claim 8, further comprising a surface-enhancing coating adhered to the outer surface of said second skin layer.

11. A labelstock for forming conformable pressure sensitive labels, comprising:
a) a facestock having sufficient stiffness to allow automated dispensing of labels formed therefrom, said facestock comprising:
a core layer including approximately 40-80% of polypropylene and approximately 20-60% of an ethylene-containing polyolefin;
first and second polyolefinic skin layers adhered to opposing sides of said core layer;
wherein said coextruded core and skin layers are biaxially oriented such that the degree of orientation in the transverse direction exceeds the degree of orientation in the machine direction, the degree of orientation in said transverse direction ranging from about 7 to about 10 and the degree of orientation in said machine direction ranging from about 3.5 to about 6; and
wherein said core layer is at least about 20 times the thickness of one of said skin layers;
b) a pressure-sensitive adhesive applied to the outer surface of said second skin layer;
c) a release liner covering said pressure-sensitive adhesive and adapted for removal therefrom.

12. The labelstock according to claim 11, wherein said core layer includes approximately 45 to 60% of said polypropylene and approximately 40 to 55% of said ethylene-containing polyolefin.

13. The labelstock according to claim 12, wherein said ethylene-containing polyolefin provides said core layer with a total ethylene content of approximately 2%-4%.

14. The labelstock according to claim 13, wherein said ethylene-containing polyolefin is selected from the group consisting of random propylene-ethylene copolymers and propylene-ethylene-butylene terpolymers.

15. The labelstock according to claim 11, wherein each of said skin layers has a thickness of less than approximately 0.1 mils, and wherein said core layer has a thickness of at least about 2.15 mils.

16. The labelstock according to claim 15, wherein each of said skin layers has a thickness of from about 0.03 mils to about 0.07 mils and said core layer has a thickness of from about 2.3 mils to about 2.4 mils, and wherein the degree of orientation in said transverse direction is approximately 8 and the degree of orientation in said machine direction is approximately 4.5.

17. The labelstock according to claim 16, wherein each of said skin layers is formed of a propylene-ethylene copolymer and includes from about 500 ppm to about 2500 ppm of an antiblock agent.

18. The labelstock according to claim 11, further comprising an acrylic-based coating adhered to the outer surface of said first skin layer.

19. The labelstock according to claim 18, wherein said coating includes a matting agent.

20. The labelstock according to claim 18, further comprising a surface-enhancing coating adhered to the outer surface of said second skin layer for enhancing adhesion of said adhesive thereto.
